(19) United States
(12) Patent Application Publication
(10) Pub. No.: US 2024/0063858 A1
(43) Pub. Date: Feb. 22, 2024

(54) Transceiver method between receiver (Rx) and transmitter (Tx) in an overloaded communication channel

(71) Applicant: Continental Automotive Technologies GmbH, Hannover (DE)

(72) Inventors: David Gonzalez Gonzalez, Egelsbach (DE); Andreas Andrae, Frankfurt am Main (DE); Osvaldo Gonsa, Frankfurt (DE); Hiroki Iimori, Yokahama (JP); Giuseppe Thadeu Freitas de Abreu, Bremen (DE)

(73) Assignee: Continental Automotive Technologies GmbH, Hannover (DE)

(21) Appl. No.: 18/257,993

(22) PCT Filed: Dec. 15, 2021
(86) PCT No.: PCT/EP2021/086005

§ 371 Date: Jun. 16, 2023

(30) Foreign Application Priority Data
Dec. 16, 2020 (DE) 10 2020 216 022.8

(51) Int. Cl. H04B 7/0456; H04B 7/06; H04B 7/08

(52) U.S. Cl. CPC H04B 7/0465; H04B 7/0617; H04B 7/0634; H04B 7/0639; H04B 7/0854

(57) ABSTRACT

Transceiver method between at least one receiver and at least one transmitter in an overloaded communication channel that is characterized by a channel matrix, wherein within a first step a transmitter sends out a reference signals to a receiver, and the receiver estimates the channel Matrix, within a second step the receiver optimizes RX beamforming matrix and TX beamforming matrix jointly, within a third step the TX beamforming matrix is sent to the transmitter out-of-band by using a control channel, which is reliable.

### CROSS-REFERENCE TO RELATED APPLICATIONS

The present application is a National Stage Application under 35 U.S.C. § 371 of International Patent Application No. PCT/EP2021/086005 filed on Dec. 15, 2021, and claims priority from German Patent Application No. 10 2020 216 022.8 filed on Dec. 16, 2020, in the German Patent Office, the disclosures of which are herein incorporated by reference in their entireties.

### FIELD

This present disclosure relates to methods and systems for beamforming, which are suitable for multiple-input multiple output (MIMO) communications including massive MIMO aims at an effective waveform design for point-to-point time-varying millimeter-wave multiple-input multiple-output (MIMO) systems distorted by phase noise induced at the radio frequency (RF) chains, i.e., local oscillators, at the transmitter and receiver.

### BACKGROUND

It is estimated that by 2030, over 100 billion wireless devices will be interconnected through emerging networks and paradigms such as the Internet of Things (IoT), fifth generation (5G) cellular radio, and its successors. This future panorama implies a remarkable increase in device density, with a consequent surge in competition for resources. Therefore, unlike the preceding third generation (3G) and fourth generation (4G) systems, in which spreading code overloading and carrier aggregation (CA) were add-on features aiming at moderately increasing user or channel capacity, future wireless systems will be characterized by nonorthogonal access with significant resource overloading.

The expressions “resource overloading” or “overloaded communication channel” typically refers to a communication channel that is concurrently used by a number of users or transmitters T whose number NT is larger than the number NR of resources R. At a receiver, the multiplicity of transmitted signals will appear as one superimposed signal. The channel may also be overloaded by a single transmitter that transmits a superposition of symbols and thereby goes beyond the available channel resources in a “traditional” orthogonal transmission scheme. The “overloading” thus occurs in comparison to schemes, in which a single transmitter has exclusive access to the channel, e.g., during a time slot or the like, as found in orthogonal transmission schemes. Overloaded channels may be found, e.g., in wireless communication systems using Non-Orthogonal Multiple Access (NOMA) and underdetermined Multiple-Input Multiple-Output (MIMO) channels.

One of the main challenges of such overloaded systems is detection at the receiver, since the bit error rate (BER) performances of well-known linear detection methods, such as zero-forcing (ZF) and minimum mean square error (MMSE), are far below that of maximum likelihood (ML) detection, which is a preferred choice for detecting signals in overloaded communication channels. ML detection methods determine the Euclidian distances, for each transmitter, between the received signal vector and signal vectors corresponding to each of the symbols from a predetermined set of symbols that might have been transmitted, and thus allow for estimating transmitted symbols under such challenging conditions. The symbol whose vector has the smallest distance to the received signal's vector is selected as estimated transmitted symbol. It is obvious, however, that ML detection does not scale very well with larger sets of symbols and larger numbers of transmitters, since the number of calculations that need to be performed for large sets in a discrete domain increases exponentially.

Millimeter-wave (mmWave) technology has been of recent interest for achieving high data rate wireless links and fulfilling the exigent requirements of increasingly bandwidth-hungry data applications. However, mmWave systems have the potential for significant path losses compared to lower frequency band systems.

Massive multiple-input multiple-out (MIMO) technology has been proposed as a solution to overcome such shortcomings of mmWave systems. The small wavelengths of mmWave systems help to facilitate the utilization of massive MIMO technology. The short wavelength allows the size of the antennas (also referred to as radiating elements or radiators) in an antenna array to be relatively small, thus enabling a large number of antennae to be implemented in an antenna array that can be easily embedded into both transmitter and receiver terminals. The use of massive MIMO technology, particularly in mmWave systems, may help to compensate for link loss in mmWave communications by employing a large number of antennae at each terminal to provide high antenna gain and thus help increase the received signal to noise power ratio (SNR).

However, implementation of massive MIMO may incur significant operational cost by requiring the use of a large number of radio frequency (RF) chains and also requiring significant overhead for channel feedback and beamforming (BF) training.

Hybrid BF technology, which combines digital precoding in the baseband domain with analog BF in the RF domain, has been of interest for reducing the number of RF chains. However, current designs of hybrid beamformers may require significant resources to communicate feedback about the channel condition between the hybrid BF receiver and the transmitter terminals. For example, a current hybrid beamformer design may require instantaneous and perfect channel state information at the transmitter terminal, which means that significant resources may be consumed by the communication of feedback from the receiver terminal.

Accordingly it would be useful to provide a design for beamforming that operates using more limited feedback.

US 2018234948 discloses an uplink detection method and device in a NOMA system. The method includes: performing pilot activation detection on each terminal in a first terminal set corresponding to a NOMA transmission unit block repeatedly until a detection end condition is met, wherein the first terminal set includes terminals that may transmit uplink data on the NOMA transmission unit block; performing channel estimation on each terminal in a second terminal set that determined through the pilot activation detection within each repetition period, wherein the second terminal set includes terminals that have actually transmitted uplink data on the NOMA transmission unit block; and detecting and decoding a data channel of each terminal in the second terminal set within each repetition period. US 2018234948 describes a PDMA, pilot activation detection and heuristic iterative algorithm.

WO 2017071540 Al discloses a signal detection method and device in a non-orthogonal multiple access, which are used for reducing the complexity of signal detection in a non-orthogonal multiple access. The method comprises; determining user nodes with a signal-to-interference-and-noise ratio greater than a threshold value, forming the determined user nodes into a first set, and forming all the user nodes multiplexing one or more channel nodes into a second set; determining a message transmitted by each channel node to each user node in the first set by means of the first L iteration processes, wherein L is greater than 1 or less than N, N being a positive integer; according to the determined message transmitted by each channel node to each user node in the first set by means of the first L iteration processes, determining a message transmitted by each channel node to each user node in the second set by means of the (L+1)th to the Nth iteration processes; and according to the message transmitted by each channel node to each user node in the second set, detecting a data signal respectively corresponding to each user node. This means WO 2017071540 characterizes PDMA, thresholding based signal detection, iterative log likelihood calculation

US 2018102882 Al describes a downlink non-orthogonal multiple access using a limited amount of control information. A base station device that adds and transmits symbols addressed to a first terminal device and one or more second terminal devices, using portion of available subcarriers, includes: a power setting unit that sets the first terminal device to a lower energy than the one or more second terminal devices; a scheduling unit that, for signals addressed to the one or more second terminal devices, performs resource allocation that is different from resource allocation for a signal addressed to the first terminal device; and an MCS determining unit that controls modulation schemes such that, when allocating resources for the signal addressed to the first terminal device, the modulation schemes used byr the one or more second terminal devices, to be added to the signal addressed to the first terminal device, are the same. US 2018102882 A1 depicts a Power Domain NOMA, a transmit and a receive architecture design.

WO 2017057834 A1 publishes a method for a terminal to transmit signals on the basis of a non-orthogonal multiple access scheme in a wireless communication system may comprise the steps of: receiving, from a base station, information about a codebook selected for the terminal in pre-defined non-orthogonal codebooks and control information including information about a codeword selected from the selected codebook: performing resource mapping on uplink data to be transmitted on the basis of information about the selected codebook and information about the codeword selected from the selected codebook: and transmitting, to the base station, the uplink data mapped to the resource according to the resource mapping. WO 2017057834 reveals a Predesigned codebook based NOMA, parallel interference cancellation, successive interference cancellation, a transmit and a receive architecture design.

WO 2018210256 A1 discloses a bit-level operation. This bit-level operation is implemented prior to modulation and resource element (RE) mapping in order to generate a NoMA transmission using standard (QAM, QPSK, BPSK, etc.) modulators. In this way, the bit-level operation is exploited to achieve the benefits of NoMA (e.g., improved spectral efficiency, reduced overhead, etc.) at significantly less signal processing and hardware implementation complexity. The bit-level operation is specifically designed to produce an output bit-stream that is longer than the input bit-stream, and that includes output bit-values that are computed as a function of the input bit-values such that when the output bit-stream is subjected to modulation (e.g., m-ary QAM, QPSK, BPSK), the resulting symbols emulate a spreading operation that would otherwise have been generated from the input bit-stream, either by a NoMA-specific modulator or by a symbol-domain spreading operation. WO 2018210256 offers a solution for Bit-level encoding and NOMA transmitter design.

WO 2017204469 Al provides systems and methods for data analysis of experimental data. The analysis can include reference data that are not directly generated from the present experiment, which reference data may be values of the experimental parameters that were either provided by a user, computed by the system with input from a user, or computed by the system without using any input from a user. It is suggested that another example of such reference data may be information about the instrument, such as the calibration method of the instrument.

KR 20180091500 A is a disclosure relating to 5′th generation (5G) or pre-5G communication system to support a higher data rate than 4′th generation (4G) communication systems such as long term evolution (LTE). The present disclosure is to support multiple access. An operating method of a terminal comprises the processes of: transmitting at least one first reference signal through a first resource supporting orthogonal multiple access with at least one other terminal; transmitting at least one second reference signal through a second resource supporting non-orthogonal multiple access with the at least one other terminal; and transmitting the data signal according to a non-orthogonal multiple access scheme with the at least one other terminal, KR 20180091500 draws a solution for NOMA transmission/reception methodology using current OMA (LTE) systems with Random access and user detection

U.S. Pat. No. 8,488,711 B2 describes a decoder for underdetermined MIMO systems with low decoding complexity is provided. The decoder consists of two stages: 1. Obtaining all valid candidate points efficiently by slab decoder. 2. Finding the optimal solution by conducting the intersectional operations with dynamic radius adaptation to the candidate set obtained from Stage 1. A reordering strategy is also disclosed. The reordering can be incorporated into the proposed decoding algorithm to provide a lower computational complexity and near-ML decoding performance for underdetermined MIMO systems. U.S. Pat. No. 8,488,711 describes a Slab sphere decoder, underdetermined MIMO and with near ML performance.

JP 2017521885 A describes methods, systems, and devices for hierarchical modulation and interference cancellation in wireless communications systems. Various deployment scenarios are supported that may provide communications on both a base modulation layer as well as in an enhancement modulation layer that is modulated on the base modulation layer, thus providing concurrent data streams that are provided to the same or different user equipment's. Various interference mitigation techniques are implemented in examples to compensate for interfering signals received from within a cell, compensate for interfering signals received from other cell(s), and/or compensate for interfering signals received from other radios that may operate in adjacent wireless communications network. This means

JP 2017521885 discloses a hierarchical modulation and interference cancellation for multi-cell/multi-user systems.

EP 3427389 Al discloses a system and method of power control and resource selection in a wireless uplink transmission. An eNodeB (eNB) may transmit to a plurality of user equipments (UEs) downlink signals including control information that prompts the UEs to transmit non-orthogonal signals based on lower open loop transmit power control targets over wireless links exhibiting higher path loss levels. Lower open loop transmit power control targets may be associated with sets of channel resources with greater bandwidth capacities, such as non-orthogonal spreading sequences having higher processing gains and/or higher coding gains. When the eNB receives an interference signal over one or more non-orthogonal resources from the UEs, the eNB may perform signal interference cancellation on the interference signal to at least partially decode at least one of the uplink signals. The interference signal may include uplink signals transmitted by different UEs according to the control information. EP 3427389 gives a solution for Resource management (transmission power, time and frequency) and a transmission policy

Generally spoken and as already indicated, given the continuously increasing demands of mobile data rates and massive wireless connectivity, future communications systems will confront the shortage of wireless resources such as time, space and frequency. One of the main challenges of such overloaded systems is detection at the receiver, since the conventional linear detection methods demonstrate high error floor. To overcome this issue, several novel methods based on sphere decoding have been proposed in the past, which illustrate their capability of reaching the optimal performance, however their complexity grows as it was shown in the cited prior art exponentially with the size of transmit signal dimensions (i.e., the number of users), thus preventing their application to practical use cases, like loT and several others in future (wireless) scenarios.

While simultaneously offering high-throughput data rates as a result of an effective exploitation of the wide range of available frequencies between 24 GHz and 300 GHz, millimeter wave (mmWave) communications have intensively been developed over the last decade, targeting commercialization and industrialization in fifth generation and beyond (5G+) and sixth generation (6G) networks. To elaborate, advanced beamforming methods with either digital or hybrid architectures have been proposed in the literature. Also, specialized channel estimation strategies together with the aforementioned beamforming techniques served to demonstrate that multi-giga bits per second (Gbps) throughputs can be achieved by mmWave systems in quasi-static channel scenarios.

It has been recently recognized, however, that mmWave channels are susceptible to path blockages, which can significantly degrade system performance. In other to tackle this remaining fundamental challenge, proactive wireless control mechanisms with basis on machine learning techniques have been recently-proposed. Nevertheless, a remaining challenge is the assumption that the estimated mmWavechannel remains constant over the duration of data transmission, so that beamformers can be highly optimized for the given channel condition. While such a block-fading assumption is reasonable in a relatively stationary environment, it is certainly not the case in high-mobility scenarios including those faced in vehicle-to-everything (V2X) and unmanned aerial vehicle (UAV) communications systems.

### SUMMARY

In order to address this issue, attention has been increasingly paid to the estimation of time-varying mmWave channels as well as to non-coherent mechanisms, aiming at improving the robustness of mmWave systems to time-varying effects. Also, it has also been recently shown that in high-frequency systems, hardware impairment manifests itself most significantly in terms of phase noise, which in turn may impose harmful effects onto system performance. Although a few recent studies on the design of mmWave beamformers that compensate for imperfection due to time-varying phenomena can be found in the literature, to the best of our knowledge, an analytical mean square error (MSE) expression for the time-varying mmWave channels and the corresponding minimum mean square error (MMSE) waveform design taking both the signal time domain dynamics and phase noise into consideration simultaneously have not been investigated.

In this application, we therefore contribute a solution for this topic of non-stationary and time-varying mmWave communications with a novel robust MMSE beamforming method, which in turn is based on an original MSE analysis of such channels that also incorporates the impact of hardware imperfection modeled as phase noise at both the transmitter and receiver. A list of the major parameters utilized throughout the patent application using the Notation and Definition is given at the end of this description.

A first example embodiment of the present disclosure is given by a computer-implemented transceiver method between at least one receiver (Rx) and at least one transmitter (Tx) in an overloaded communication channel that is characterized by a channel matrix (H), wherein, within a first step a transmitter (Tx) sends out a reference signals (PILOTS) to a receiver (Rx), and the receiver (Rx) estimates the channel Matrix (H), within a second step the receiver (Rx) optimizes the RX beamforming matrix (W_{BB}) and the TX beamforming matrix (F_{BB}) jointly, within a third step TX beamforming matrix (F_{BB}) is sent to the transmitter (Tx) out-of-band by using a control channel, which is reliable.

A further example embodiment of the method is characterized in such a manner, that the RX beamforming matrix (W_{BB}) and the TX beamforming matrix (F_{BB}) are calculated in that an alternating optimization can be executed over TX beamforming matrix (F_{BB}^{MMSE}) and RX beamforming matrix (W_{BB}^{MMSE}) until a stable point is reached by optimizing a minimum mean square error (MMSE) and after convergence, and TX beamforming matrix (F_{BB}^{MMSE}) is scaled to satisfy the maximum transmit power constraint.

Another example embodiment of the method is characterized in such a manner, that a minimum mean square error (MMSE) based on a mean square error (MSE) of such channels matrixes (H) that incorporates the impact of hardware imperfection modeled as phase noise at the transmitter (Tx) and receiver (Rx).

Another example embodiment of the method is characterized in such a manner, wherein the RX beamforming matrix (W BB) and the TX beamforming matrix (F BB) are integrated in beamforming circuitry for a use in a user equipment (UE) of a wireless telecommunications network and in a basestation having at least one basestation, the beamforming circuitry receives at the user equipment (UE), from the network, data requesting a selection of at least one non-zero integer number beam by the user equipment (UE).

A very example embodiment is given by a user equipment (UE) including : a display screen; and beamforming circuitry.

A further embodiment of the present disclosure is represented by machine-readable instructions provided on at least one machine-readable medium, the machine-readable instructions, when executed by a User Equipment (UE) of a wireless telecommunications network having at least one basestation to cause processing hardware of the UE to obtain, from the network, reference signals (PILOTS) specifying one or more non-zero integer beams to be calculated according to the computer-implemented transceiver method between at least one receiver (Rx) and at least one transmitter (Tx) in an overloaded communication channel that is characterized by a channel matrix (H).

A further embodiment of the present disclosure is represented by machine readable instructions to cause processing hardware of the UE to report from the UE to the network, reference signals (PILOTS) wherein the RX beamforming matrix (W_{BB}) and the TX beamforming matrix (F_{BB}) are calculated in such a manner, that an alternating optimization can be executed over TX beamforming matrix (F_{BB}^{MMSE}) and RX beamforming matrix (W_{BB}^{MMSE}) until a stable point is reached by optimizing a minimum mean square error (MMSE) and after convergence, and TX beamforming matrix (F_{BB}^{MMSE}) is scaled to satisfy the maximum transmit power constraint.

A further embodiment of the present disclosure is represented by circuitry for use in a basestation of a wireless telecommunications network, the circuitry comprising processing circuitry to prepare the calculation of the RX beamforming matrix (W_{BB}) and the TX beamforming matrix (F_{BB}) is calculated in such a manner, that an alternating optimization can be executed over TX beamforming matrix (F_{BB}^{MMSE}) and RX beamforming matrix (W_{BB}^{MMSE}) until a stable point is reached by optimizing a minimum mean square error (MMSE) and after convergence, and TX beamforming matrix (F_{BB}^{MMSE}) is scaled to satisfy the maximum transmit power constraint.

A basestation of a wireless telecommunications network includes: a transceiver; and circuitry for use in a basestation.

### BRIEF DESCRIPTION OF THE DRAWINGS

The invention will be further explained with reference to the drawings in which

FIG. 1 shows an MSE value with respect to relative speed between transmitter and receiver;

FIG. 2 shows an MSE value with respect to OFDM symbols within a OFDM frame;

FIG. 3 shows an MSE value with respect to OFDM symbols within a OFDM frame; and

FIG. 4 shows the system parameters and inventive computation.

### DETAILED DESCRIPTION

In this patent application, we contribute non-stationary and time-varying mmWave communications with a novel robust MMSE beamforming method, which in turn is based on an original MSE analysis of such channels that also incorporates the impact of hardware imperfection modeled as phase noise at both the transmitter and receiver. The core of the method is:
1) Given the system parameters (i.e., CS! knowledge obtained at the preceding channel estimation process, relative speed between TX and RX, phase noise variance), compute (Si);
2) For an obtained solution (S1), compute (S2);
3) Iteratively compute (S1) and (S2) until they converge; and
4) End the method.

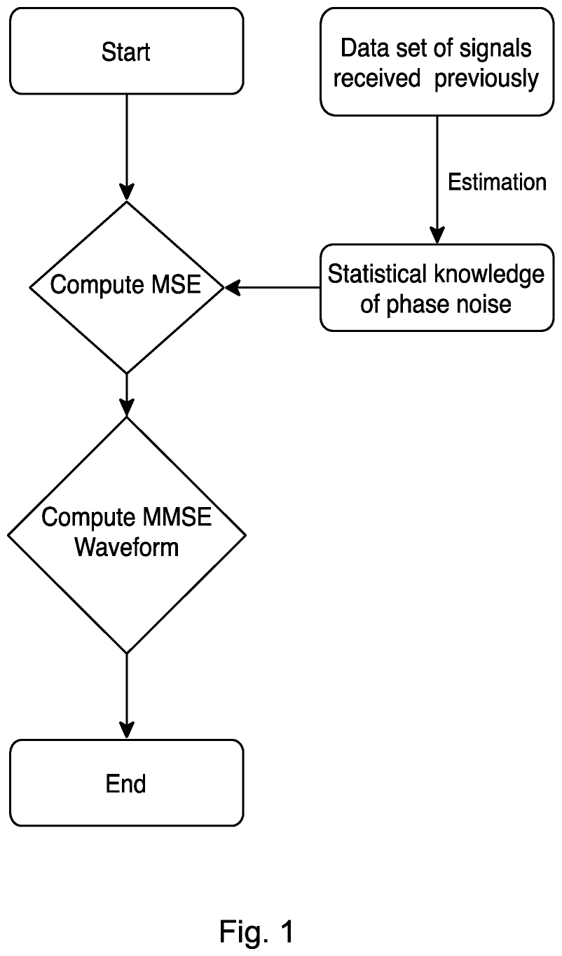

In FIG. 1 a data set of signals received previously are used in order to calculate an estimation to obtain a statistical knowledge of phase noise. Afterwards, the mean square error is calculated, and the minimum mean square error waveform is computed, which captures simultaneously the effects of phase noise as caused by hardware imperfections as well as of channel aging caused by high-mobility scenarios, such as V2X and UAV. In that approach, a convergence-guaranteed, alternate optimization-based MMSE beamforming method is designed to minimize the latter MSE expression, and thus solve both problems at once. The advantage of the proposed method over state-of-the-art alternatives in terms of MSE performance is confirmed via software simulation. Due to the tractability of the MSE expression, an extension of this method to other beamforming schemes designed to address other metrics such as rate-maximum alternative in conjunction with other interesting factors such as wideband transmission, hardware imperfection, path blockage, discrete phase shifting limitations, integration with intelligent reflecting surface (IRS) can also be considered as a direct extension of this application. Generally spoken in a first step the system parameters given, i.e., CSI knowledge obtained at the preceding channel estimation process, relative speed between TX and RX, phase noise variance. The end of the method is achieved and use of the final solutions for beamforming matrices at RX and TX.

In this application, a non-stationary and time-varying mmWave communications with a novel robust MMSE beamforming method is described, which in turn is based on an original MSE analysis of such channels that incorporate also the impact of hardware imperfection modeled as phase noise at both the transmitter and receiver. For the sake of readability, a list of the major parameters utilized throughout the application is given.

### Channel and System Model

In this section, we introduce the channel and system models considered throughout the application, characterizing the effects of phase noise as well as channel aging phenomena in high-mobility mmWave communication systems.

Following existing literature, the well-known clustered mmWave channel model with L clusters, each having [symbol] rays with [symbol] ε [symbol] {1,2, . . . ,L}, is hereafter considered so as to capture the sparsely scattered nature of mmWave channels, described in details in the next subsection.

Channel Model

Consider a mmWave multiple-input multiple-output (MIMO) system in which both the transmitter and the receiver are equipped with equi-spaced square planar arrays with Nₜ and Nᵣ antennas, respectively, such that both transmit and receive beamforming can be performed offering with elevation and azimuth control. Then, the corresponding channel matrix can be written as,

$$H = \frac{1}{\sqrt{L}} {\sum }_{ℓ = 1}^{L} {\sum }_{c = 1}^{{C}_{ℓ}} \frac{{σ}_{ℓ , c}}{\sqrt{{C}_{ℓ}}} {a}_{{N}_{r}} ( {θ}_{ℓ , c}^{R X} , {ϕ}_{ℓ , c}^{R X} ) {a}_{{N}_{t}}^{H} ( {θ}_{ℓ , c}^{T X} , {ϕ}_{ℓ , c}^{T X} ) \qquad ( 1 )$$

where [symbol] and [symbol] are respectively the elevation angle of arrival (AoA) and angle of departure (AoD) corresponding to the c-th ray of the [symbol] -th scattering cluster [symbol] and [symbol] respectively denote the azimuth AoA and AoD corresponding to t he c-th ray of the [symbol] -th scattering

$${σ}_{ℓ , c} ∼ 𝒞𝒩 ( 0 , 1 )$$

model small-scale channel fading coefficients; and the array response vector is given by

$${a}_{N} ( θ , ϕ ) = {c}_{\sqrt{N}} ( sin ( θ ) cos ( ϕ ) ) ⊗ {c}_{\sqrt{N}} ( cos ( θ ) ) \qquad ( 2 )$$

$$with$$

$${c}_{\sqrt{N}} ( x ) {=}^{△} {\frac{1}{\sqrt{N}} [ 1 , {e}^{j π x} , … , {e}^{j π ( \sqrt{N} - 1 ) x} ]}^{T} \qquad ( 3 )$$

Focusing on systems employing coherent orthogonal frequency division multiplexing (OFDM) signaling, most of the existing state-of the-art waveform design methods found in the related literature seek to jointly optimize transmit and receive beamforming matrices, under the assumption that the estimated channel matrix is preserved during the data transmission, i.e., coherence time interval. While this classic block-fading channel assumption holds in the case of low-mobility telecommunication systems, including the preceding generations of broadband cellular networks, it has been shown that, in real-life, mmWave OFDM-MIMO systems may suffer from a channel-aging phenomenon, which cannot be ignored in high-mobility scenarios such as V2X applications.

In particular, the aging of small-scale fading coefficients [symbol] appearing in equation (1) can be incorporated by employing the first-order AR model

$${σ}_{ℓ , c} ( τ ) = \{ \begin{matrix}𝒞𝒩 ( 0 , 1 ) & τ = 0 \\ r {σ}_{ℓ , c} ( τ - 1 ) + \sqrt{1 - {r}^{2}} {ω}_{ℓ , c} ( τ ) & τ ∈ {ℤ}_{+}\end{matrix} \qquad ( 4 )$$

where [symbol] ₊ denotes the set of strictly positive integers, the time-varying component

$${ω}_{ℓ , c} ( τ ) ∼ 𝒞𝒩 ( 0 , 1 )$$

and the time correlation parameter r is defined as

$$r ( Δτ ) {=}^{△} \frac{{𝔼}_{τ} [ {σ}_{ℓ , c}^{*} ( τ ) {σ}_{ℓ , c} ( τ + Δ τ ) ]}{{𝔼}_{τ} [ \vert {σ}_{ℓ , c} ( τ ) {\vert}^{2} ]} \qquad ( 5 )$$

Denoting the number of OFDM symbols during data transmission by N such that the time index τ∈{0,1, . . . , N−1}, (1) can be rewritten in view of equation (4) as

$$H ( τ ) = \frac{1}{\sqrt{L}} {\sum }_{ℓ = 1}^{L} {\sum }_{c = 1}^{{C}_{ℓ}} \frac{{σ}_{ℓ , c}}{\sqrt{{C}_{ℓ}}} {a}^{RX} ( {θ}_{ℓ , c}^{R X} , {ϕ}_{ℓ , c}^{R X} ) {a}^{{TX}^{H}} ( {θ}_{ℓ , c}^{T X} , {ϕ}_{ℓ , c}^{T X} ) \qquad ( 6 )$$

where it is assumed that the AoAs and AoDs are constant during the OFDM frame interval. Taking into account that an OFDM frame interval is normally set to a few milliseconds, e.g., 10 ms in context of fifth generation (5G) new radio (NR), it is reasonable to assume that changes in the angle domain can be considered minimal, compared to those of the small-scale fading quantities.

Since the correlation parameter r defined in equation (5) is a function of Δτ, while the AR model in equation (4) requires a constant, it is necessary for analytical purposes to derive a most representative value of τ from system and environmental parameters of the intended application. To that end, let the coherence time interval be denoted by T_{c} and given by

$${T}_{c} {=}^{△} 0.423 \cdot \frac{{v}_{c}}{v} \cdot \frac{1}{{f}_{c}} = 0.4 \; 23 \cdot \frac{{λ}_{c}}{v} \qquad ( 7 )$$

where ν_{c} is the speed of light, ν denotes the relative speed between the transmitter and receiver, and ƒ_{c} and λ_{c} describe the carrier frequency and wavelength, respectively.

Please note that the coherence time T_{c} given in equation (7) is defined to be a duration of time within which the channel auto-correlation function is above 0.5. With that clarified, considering that the OFDM system operates with a discrete Fourier transform (DFT) of size D and a sampling rate p, the duration of each OFDM symbol is given by

$${T}_{s} = D \cdot \frac{( 1 + γ )}{ρ} [ s ] \qquad ( 8 )$$

where γ denotes the guard interval.

Given equations (7) and (8), the maximum number of OFDM symbols Nₘₐₓ within the coherence time defined above can be written as

$${N}_{max} = ⌊ \frac{{T}_{c}}{{T}_{s}} ⌋ = ⌊ \frac{0 \text{.423} \cdot {λ}_{c} \cdot ρ}{D \cdot ( 1 + γ ) \cdot v} ⌋ \geq N \qquad ( 9 )$$

where the last inequality is a reminder that the OFDM block (i.e., the total transmission period) is contained within the coherence time.

Finally the time correlation parameter τ to be used in the AR model can then be calculated from the aforementioned system and environmental parameters as, ^{2 2} Please note that in equation (10) the term inside the exponential is always non-positive, since log (0.5)<0, indicating that the correlation parameter τ is inversely proportional to the velocity ν as expected.

$$r = exp [ \frac{log ( 0.5 )}{{N}_{max}} ] = exp [ log ( 0.5 ) \cdot {⌊ \frac{0 \text{.423} \cdot {λ}_{c} \cdot ρ}{D \cdot ( 1 + γ ) \cdot v} ⌋}^{- 1} ] \qquad ( 10 )$$

In light of the above, equation (6) can be developed so as to express the relationship between the aged channel H(τ) and the known (estimated) channel H(0), namely,

$$H ( τ ) = {\underbrace{{r}^{τ} H ( 0 )}}_{known} + {\underbrace{\sqrt{\frac{1 - {r}^{2}}{L}} {\sum }_{ℓ = 1}^{L} {\sum }_{c = 1}^{{C}_{ℓ}} {\sum }_{t = 0}^{τ - 1}}}_{{t}^{t} \frac{{ω}_{ℓ , c} ( τ - t )}{\sqrt{{C}_{ℓ}}} {A}_{ℓ , c}} \qquad ( 11 )$$

where

$${A}_{ℓ , c} {=}^{△} {a}^{R X} ( {θ}_{ℓ , c}^{R X} , {ϕ}_{ℓ , c}^{R X} ) {a}^{T {X}^{H}} ( {θ}_{ℓ , C}^{T X} , {ϕ}_{ℓ , c}^{T X} ) ,$$

such that at τ=0 we simply have H(0), and τ^{z} denotes τ to the power of z, with z ∈ [symbol] where [symbol] denotes the set of integers.

System Model

Given the time-varying channel model described in the previous subsection, we now describe the received signal model of a point-to-point mmWave OFDM-MIMO communication system, in which both the transmitter and the receiver are equipped with a fully-digital beamforming architecture. ³

The fully-digital waveform construction assumed is required in order to enable the analysis of the achievable performance of high-mobility time-varying mmWave OFDM-MIMO systems. In practice, it is known that near optimal hybrid beamforming can be obtained via hybrid beamforming methods.

Furthermore, with the aim of determining the achievable system performance, we hereafter consider a dynamic beamforming mechanism in a similar fashion to symbol-level precoding methods found in the interference exploitation (IE) literature. Although a static (fixed) low-complexity alternative to dynamic beamforming can be seen as a special case of the latter, this assumption is to illustrate the achievable performance gained from awareness of channel aging.

Denoting the transmit and receive beamforming matrices respectively by F_{BB} (τ) ∈ [symbol] ^{Nt}^{^{+α}}and W_{BB}(τ) ∈ [symbol] ^{x×Nr}, and utilizing equation (11), the received signal vector at the time indes τ is given by

$$y ( τ ) = {{r}^{τ} {W}_{B B} ( τ ) {E}_{r x} ( τ ) H ( 0 ) {E}_{t x} ( τ ) {F}_{B B} ( τ ) s ( τ )}^{\overbrace{intended signal}} + {\underbrace{{W}_{B B} ( τ ) {E}_{r x} ( τ ) Γ ( τ ) {E}_{t x} ( τ ) {F}_{B B} ( τ ) s ( τ ) + {W}_{B B} ( τ ) n ( τ )}}_{disturbance due to channel aging and noise} \qquad ( 12 )$$

where S ∈ [symbol] ^{d×1} is a transmit symbol vector with d symbols, n expresses an independent and identically distributed (i.i.d.) circularly symmetric additive white 10 Gaussian noise (AWGN) vector with zero mean and covariance N₀I_{N}_{ᵣ}, and eₜₓ and Eᵣₓ are phase noise matrices modeled following as Eₜₓ(τ)=diag ({exp (−iaₙ)}ₙ₌₁^{N}^{ₜ}) ∈ [symbol] ^{N}^{ₜ}^{×N}^{ₜ} and Eᵣₓ(τ)
diag ({exp (−iβⱼ)}ⱼ₌₁^{N}^{ᵣ}) ∈ [symbol] ^{N}^{ᵣ}^{×N}^{ᵣ} with αₙ and βⱼ being random phase noise variables, repectively, and

$$Γ ( τ ) {=}^{△} \sqrt{\frac{1 - {r}^{2}}{L}} {\sum }_{ℓ = 1}^{L} {\sum }_{c = 1}^{{C}_{ℓ}} {\sum }_{t = 0}^{τ - 1} {r}^{t} \frac{{ω}_{ℓ , c} ( τ - t )}{\sqrt{{C}_{ℓ}}} {A}_{ℓ , c} \qquad ( 13 )$$

which is introduced to simplify notation.

### SE Analysis

Taking into account the channel and signal model described above, we present in this section one of our main contributions, namely the MSE analysis of equation (12).

Motivated by the fundamental relationship that minimizing MSE has with improving various performance objectives, and in line with precedence on MMSE-based beamforming, we aim to enable the design of MMSE-based beamformers that can simultaneously compensate for channel-aging interference and hardware imperfection in the form of phase noise. To this end, consider the MSE function defined as the average squared error between the received signal and the transmitted symbol vectors, namely

$$\begin{matrix}{ℳ}_{τ} {=}^{△} 𝔼 [ {‖ y ( τ ) - s ( τ ) ‖}^{2} \vert {W}_{B B} ( τ ) , {F}_{B B} ( τ ) , H ( 0 ) , {A}_{ℓ , c} \\ = 𝔼 [ Tr ( y ( τ ) {y}^{H} ( τ ) ) ] - 𝔼 [ Tr ( y ( τ ) {s}^{H} ( τ ) ) ] \\ = 𝔼 [ Tr ( s ( τ ) {y}^{H} ( τ ) ) ] + 𝔼 [ Tr ( s ( τ ) {s}^{H} ( τ ) ) ]\end{matrix} \qquad ( 14 )$$

where we assume that the transmitted symbols are normalized and independently drawn from a given constellation.

In order to obtain a more tractable expression of the MSE function [symbol] _{τ}, an analysis of the cross correlation term [symbol] [Tr (y(τ)s^{H}(τ))] as well as of the mean received signal power [symbol] [Tr (y(τ)y^{H}(τ))] are necessary. Motivated by the above, we introduce the following lemma.

Lemma 1: Let X ∈ [symbol] ^{N}^{ᵣ}^{×N}^{ₜ}. Then the following holds

[symbol]

αₙ, βⱼ∀(n,j)[EᵣₓXEₜₓ]=Mᵣₓ^{E}XMₜₓ^{E} (15)

where

Mₜₓ^{E} [symbol] diag {φ(αₙ)}ₙ₌₁^{N}^{ₜ}, Mᵣₓ^{E} [symbol] diag {φ(βⱼ)}ⱼ₌₁^{N}^{ᵣ} (16)

with φ(·) denoting the characteristic function. Proof: Notice that the expectations of Eₜₓ and Eᵣₓ are respectively equivalent to the Fourier transforms of the random variables αₙ and βⱼ with frequency parameter 1, which implies that the averaged n-th and j-th diagonal elements of Eₜₓ and Eᵣₓ can be respectively written as

[symbol]

αₙ[[Eₜₓ]_{n,n}]=ƒ_{-∞}^{∞}p(αₙ)exp (−aαₙ)dαₙ

[symbol]

βⱼ[[Eᵣₓ]_{j,j}]=ƒ_{-∞}^{∞}p(βⱼ)exp (−iβⱼ)dβⱼ (17a, b)

where p(αₙ) and p(βᵢ) are the distributions of the phase noise variates αₙ and βⱼ, respectively, from which it is immediately recognized that [symbol] _{α}_{ₙ}[[Eₜₓ]_{n,n}] and [symbol] _{β}_{ⱼ}[[Eᵣₓ]_{j,j}] are their characteristic functions, completing the proof.

Taking advantage of the above, the cross-correlation term [symbol] [Tr(y(τ)s^{H}(τ))] can be rewritten as

[symbol]

[Tr(y(τ)s^{H}(τ))]=τ^{τ}Tr(W_{BB}(τ)Mᵣₓ^{E}(τ)H(0)Mₜₓ^{E}(τ)F_{BB}(τ)) (18)

where that fact that [symbol] r(τ)] vanishes is a consequence of the zeromeanness of the time-varying parameter [symbol] .

To facilitate further analyses of the MSE function, we present the following lemma.

Lemma 2: Let X ∈ [symbol] ₊^{N×N} and E=diag ({exp (−iξₙ)}ₙ₌₁^{N}) where [symbol] ₊ denotes the set of Hermitian positive semidefinite matrices. Letting ○ be the Hadamard product, then

[symbol]

_{E}[EXE^{H}]=X○Ψ (19)

where Ψ [symbol] [diag (E)diag (E)^{H}]∈ [symbol] ^{N×N}, that is,

$$Ψ = [ \begin{matrix}1 & ψ ( {ξ}_{1} + {ξ}_{2} ) & … & ψ ( {ξ}_{1} + {ξ}_{N} ) \\ ψ ( {ξ}_{2} + {ξ}_{1} ) & 1 & ⋱ & ⋮ \\ ⋮ & ⋱ & ⋱ & ψ ( {ξ}_{N - 1} + {ξ}_{N} ) \\ ψ ( {ξ}_{N} + {ξ}_{1} ) & … & ψ ( {ξ}_{N} + {ξ}_{N - 1} ) & 1\end{matrix} ] , \qquad ( 20 )$$

and X ○Ψ∈ [symbol] ₊^{N×N} holds due to the Schur product theorem.

Proof: Equation (19) can be obtained by observing that the diagonal elements of EXE^{H} are equivalent to those of X and each non-diagonal element is scaled by a cross-term composed of two exponentials, which boils down to taking expectation of the characteristic function of two independent phase-shifting parameters as shown in equation (20).

Next, we turn our attention to the mean received signal power, which is given by

$$𝔼 [ Tr ( y ( τ ) {y}^{H} ( τ ) ) ] = {r}^{τ} Tr ( {W}_{B B} ( ( H ( 0 ) ( {F}_{B B} {F}_{BB}^{H} ∘ {Ψ}_{t x} ) {H}^{H} ( 0 ) ) ∘ {Ψ}_{r x} ) {W}_{B B}^{H} ) + Tr ( {W}_{B B} ( Σ ∘ {Ψ}_{r x} ) {W}_{B B}^{H} ) + {N}_{0} T r ( {W}_{B B} {W}_{B B}^{H} ) \qquad ( 21 )$$

where the last equality follows from Lemma 2, and we have for notation simplicity omitted the time index r and implicitly defined the quantities Ψₜₓ [symbol] [symbol] [diag (Eₜₓ)diag (Eₜₓ)^{H}], Ψᵣₓ [symbol] [diag (Eᵣₓ)diag (Eᵣₓ)^{H}] and

$$Σ {=}^{△} \frac{1 - {r}^{2}}{L} {\sum }_{ℓ = 1}^{L} {\sum }_{c = 1}^{{C}_{ℓ}} {\sum }_{t = 0}^{τ - 1} \frac{{r}^{2 t}}{{C}_{ℓ}} {A}_{ℓ , c} ( {F}_{B B} {F}_{BB}^{H} ∘ {Ψ}_{t x} ) {A}_{ℓ , c}^{H} \qquad ( 22 )$$

Substituting equations (18) and (21) into equation (14), we finally obtain

$${ℳ}_{τ} = {r}^{τ} Tr ( {W}_{B B} ( ( H ( 0 ) ( {F}_{B B} {F}_{BB}^{H} ∘ {Ψ}_{t x} ) {H}^{H} ( 0 ) ) ∘ {Ψ}_{r x} ) {W}_{B B}^{H} ) + Tr ( {W}_{B B} ( Σ ∘ {Ψ}_{r x} ) {W}_{B B}^{H} ) + {N}_{0} T r ( {W}_{B B} {W}_{B B}^{H} ) - {r}^{τ} T r ( {W}_{B B} {M}_{r x}^{E} H ( 0 ) {M}_{t x}^{E} {F}_{B B} ) - {r}^{τ} T r ( {F}_{B B}^{H} {M}_{t x}^{E} {H}^{H} ( 0 ) {M}_{r x}^{E} {W}_{B B}^{H} ) + d \qquad ( 23 )$$

where the time index is omitted when not needed, in order to avoid redundancy, and (23) captures the MSE loss due to the channel aging as well as phase noise, which can be mitigated by minimizing [symbol] _{τ}.

### 6. MMSE Waveform Design

In this section, we build on the MSE analysis of the preceding section and introduce our second contribution, namely, a novel MMSE waveform design method capable of mitigating both the time-varying distortion caused by channel aging and the phase noise caused by hardware imperfection.

### 7. A. Proposed Design

By force of the Schur product theorem, the MSE expression given in equation (23) possesses convexity with respect to seperately W_{BB} and F_{BB}. Nevertheless, the MSE function itself is non-convex due to the coupling between W_{BB} and F_{BB}, such that the minimization of M_{τ}via alternating optimization frameworks requires caution.

For a fixed F_{BB}, however, the MMSE design of W_{BB} can be obtained by taking the Wirtinger derivative of equation (23)

$$\frac{\partial {ℳ}_{τ}}{\partial {W}_{B B}^{*}} = {W}_{B B} \{ {r}^{τ} {H}_{eff}^{w} + Σ ∘ {Ψ}_{rx} + {N}_{0} {I}_{{N}_{r}} \} - {r}^{τ} {F}_{B B}^{H} {M}_{t x}^{E} {H}^{H} ( 0 ) {M}_{rx}^{E} \qquad ( 24 )$$

whose solution is given by

W_{BB}^{MMSE}=τ^{τ}F_{BB}^{H}Mₜₓ^{E}H^{H}(0)Mᵣₓ^{E}{τ^{τ}H_{eff}^{w}+Σ○Ψᵣₓ+N₀I_{N}_{ᵣ}}⁻¹ (25)

where H_{eff}^{w} [symbol] ([H(0)(F_{BB}F_{BB}^{H}]○Ψᵣₓ)

Similarly, by the cyclic property of the trace operation, the MMSE filter at the transmitter can be obtained as

$$\frac{\partial {ℳ}_{τ}}{\partial {F}_{B B}^{*} ( τ )} = \{ {r}^{τ} {H}_{eff}^{f} + \hat{Σ} ∘ {Ψ}_{t x} \} {F}_{B B} - {r}^{τ} {M}_{t x}^{E} {H}^{H} ( 0 ) {M}_{rx}^{E} {W}_{B B}^{H} \qquad ( 26 )$$

which yields

F_{BB}^{MMSE}=τ^{τ}{τ^{τ}H_{eff}^{f}+(\hat{Σ}○Ψₜₓ)}⁻¹Mₜₓ^{E}H^{H}(0)Mᵣₓ^{E}W_{Bb}^{H} (27)

where H_{eff}^{f} [symbol] ([H^{H}(0) ((W_{BB}^{H}W_{BB})○Ψᵣₓ)H(0)]○Ψₜₓ)

Taking advantage of equations (25) and (27), alternating optimization can be executed over and Wr sE until a stable point is reached. Convergence of the defined alternating method is guaranteed as follows. Since equation (25) and (27) minimizes the MSE cost function in an alternating fashion, the cost function monotonically decreases in each step. Together with the fact that the MSE cost function is always non-negative (i.e., bounded from below) with respect to the variables W_{BB} and F_{BB}, the defined alternating procedure leads to a necessary convergence to a stable point. After convergence, Fa msE is scaled so as to satisfy the maximum transmit power constraint.

Framework Extensions

As shown in with the utilization of the MMSE receive filter given in equation (25), we can readily extend the MSE minimization for F BB to be its rate maximization alternative by applying given by

Lemma 3: Let X ∈ [symbol] ^{N×N}. Then, the maximization of −log |X is equivalent to minimization of Tr (SX)−log |S| over X where we have S=X⁻¹ at the optimality.

Given Lemma 3, one may readily notice that the rate maximization filters can be obtained from a weighted version of the minimization problem of equation (23) with its weight matrix S calculated from W_{BB}^{MMSE} and F_{BB}^{MMSE} updated at the previous iteration via equation (25) and (27), although the resultant explicit expression is omitted due to the space limitation and the fact that the scope of this subsection is to illustrate a possible extension of the MSE study given in this application. As a result, the above procedure holds a similar structure to the proposed MMSE design and therefore can be solved via the alternating optimization framework.

### Performance Evaluation

In this section, we conduct simulated performance assessments of the proposed beamforming scheme, comparing it to two state-of-the-art alternatives, i.e., the MMSE-beamforming design of and the rate-optimal eigen-beamforming design of both of the latter operating under the assumption that H(0) is stationary over the duration of data transmission.

The simulation setup is aligned with IEEE 802.11ad specifications, with the carrier frequency ƒ_{c}=60 [GHz], the DFT size D=512, the guard interval y is assumed to be a quarter of each OFDM symbol length, and the OFDM sampling rate p=2640[MHz] The number of clusters and rays-per-cluster is assumed to be L=2 and [symbol] 15, respectively, while the number of OFDM symbols is set to N=256 and that of the data streams is d=2. Finally, the relative speed between the transmitter and receiver is varied in the range of [10,50][kmph], as typically considered for low-speed urban scenarios in V2X communication systems. For the sake of simplicity, the transmit power ∥F_{BB}∥_{F}² is normalized in the simulation so that the signal-to-noise-ratio (SNR) can be solely expressed as a function of the noise power N₀.

The phase noise variances σ_{α}_{ₙ}² and σ_{β}_{ⱼ}² are assumed to be identical and b a n =σ_{β}_{ⱼ}²=0.01 for all i and j. It is useful to remark that phase noise is generally best modeled as von Mises (also known as Tikhonov) random variables, such that the corresponding characteristic function is given by

$$ψ ( {α}_{n} ) = \frac{1}{2} ( 1 + 2 {\sum }_{ϕ = 1}^{∞} \frac{{I}_{n} ( {κ}_{n} )}{ln ( {κ}_{n} e )} )$$

with I_{ϕ}(⋅) depicting the modified Bessel function of order ϕ. At very low variances, however, the zero-mean Tikhonov and the Normal distributions become practically indistinguishable. Consequently, although Lemma 1 is applicable to any distribution, for the sake of simplicity we here model αₙ and βⱼ as zero-mean Gaussian random variables, i.e., αₙ˜ [symbol] (0, σ_{α}_{ₙ}²) and βⱼ˜ [symbol] (0, σ_{βj}²), with characteristic functions respectively given by φ(αₙ)=exp (−σₐ_{ₙ}²/2) and φ(βⱼ)=exp (−σ_{β}_{ⱼ}²/2). It is emphasized that in case of low variance such as one considered in this application, the Normal approximation instead of the von Mises distribution is a valid choice in this context.

As for the complexity of the proposed method in comparison with that of the conventional approaches, the complexity order of the proposed algorithm is ∂(max(Nₜ³, Nᵣ³)) due to the matrix inversion given in equations (25) and (27). Conventional approaches (i.e., MMSE and Rate-optimal methods) also feature the same complexity order, respectively, as they require the matrix inversion and singular value decomposition (SVD). Thus, with respect to conventional approaches. the proposed method provides significant performance gain at no cost in terms of complexity order.

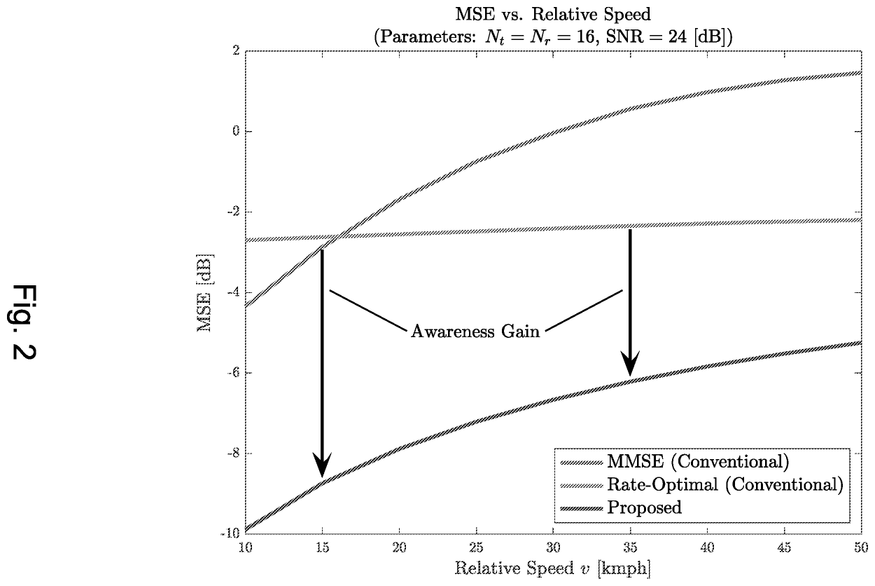

The comparisons start with FIG. 2, where the MSE of each digital data stream, averaged over different time indexes within an OFDM frame, is shown as a function of the relative speed ν[kmph] at the moderate SNR=24[dB]. As can be observed from the FIG. 2, the MMSE approach is found to be sensitive to v, exhibiting relatively low MSE values in low-mobility scenarios, but severe error levels at higher speeds. In turn, the rate-optimal method, while outperformed by the MMSE method of at low mobility, shows a slower increasing trend in response to the growth of ν, demonstrating more resilience than the latter to channel dynamics.

Still, both of these state-of-the-art methods are found to be substantially outperformed by the proposed scheme, which shows a remarkable improvement over both preceding methods across the entire range of relative velocities ν, which results from its ability to mitigate both channel-aging and phase noise caused by hardware imperfection, as modeled in equation (23).

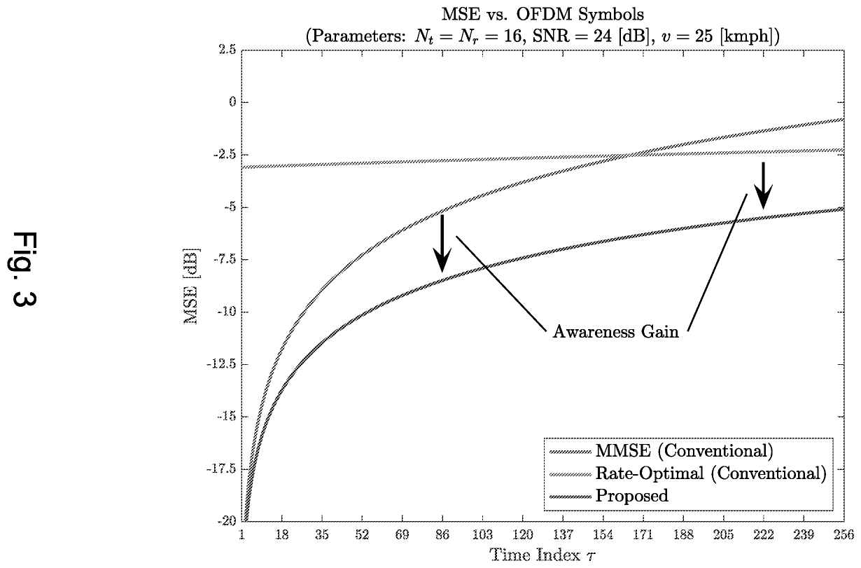

Next, we take a closer look at the performances of the three methods compared in terms of their resilience to channel aging. To elaborate, in FIG. 2 the average performance of the three distinct methods taken over the 256 symbols of OFDM frame were compared. In turn, in FIG. 3 we plot the MSE achieved by the methods as a function of the time index τ, in other words, in terms of each OFDM symbol within an OFDM frame. For completeness, both the point by point average (solid lines) over multiple realizations and their standard deviations (shaded area) of the achieved MSE are shown. It can be seen that the proposed method not only outperforms the state-of-the-art alternatives in terms of the average error of each symbol (i.e., at each τ) , but also reduces the MSE fluctuation compared to the conventional MMSE counterpart.

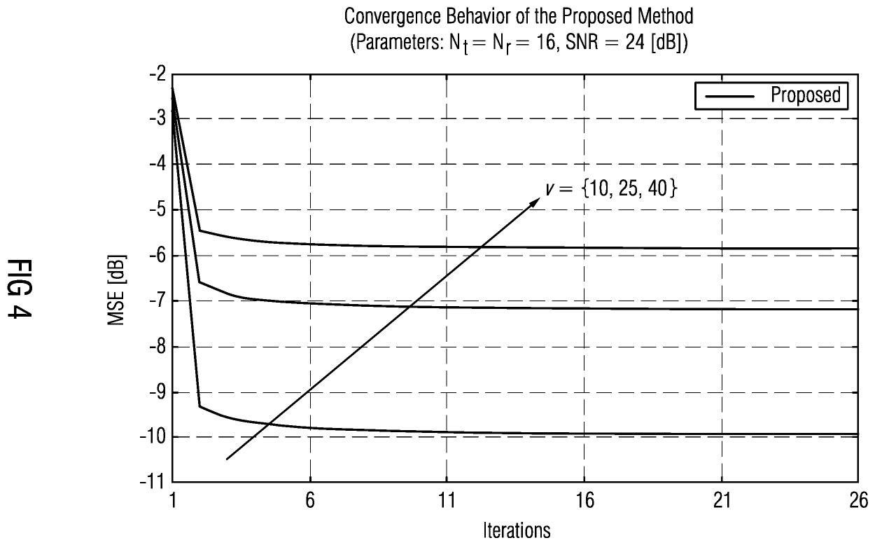

Finally, FIG. 4 depicts the convergence of the proposed method as a function of iterations for different speeds v. Although the convergence itself is guaranteed by as described, FIG. 4 also demonstrates a fast convergence behavior regardless of the speed, indicating that the proposed method can converge with a few number of iterations (i.e., less than 5 iterations). From the above, not only the robustness of the proposed method but also its stability against different system setups can been proven.

The application describes two contributions to the area of mmWave MIMO systems. The first is a novel expression of the MSE of such systems, which captures simultaneously the effects of phase noise as caused by hardware imperfections, as well as of channel aging caused by high-mobility scenarios, such as V2X and UAV. The second is a convergence-guaranteed, alternate optimization-based MMSE beamforming method designed to minimize the latter MSE expression, and thus combat both problems at once. The advantage of the proposed method over state-of-the-art alternatives in terms of MSE performance is confirmed via software simulation. It is remarked that due to the tractability of the MSE expression here presented, an extension of this application to other beamforming schemes designed to address other metrics such as rate-maximum alternative in conjunction with other interesting factors such as wideband transmission, hardware imperfection, path blockage, discrete phase shifting limitations, integration with intelligent reflecting surface (IRS) can also be considered as a direct extension of this application.

### Abbreviation of Key Quantities, Parameters and Symbols

| Notation | Definition |
|---|---|
| L | Number of clusters |
| [symbol] | Number of rays of [symbol] -th cluster |
| Nₜ | Number of TX antennas |
| Nᵣ | Number of RX antennas |
| [symbol] | Elevation angle at RX and TX, respectively |
| and | |
| [symbol] | |
| [symbol] | Azimuth angle at RX and TX, respectively |
| and | |
| [symbol] | |
| H | Channel matrix |
| [symbol] (τ) | Small-scale fading coefficient at τ-th time slot |
| r | Time correlation parameter |
| T_{c} | Coherence time |
| Tₛ | Symbol duration |
| y(τ) | RX signal at τ-th time slot |
| s(τ) | TX signal at τ-th time slot |
| n | Noise vector |
| W_{BB} | RX beamforming matrix |
| F_{BB} | TX beamforming matrix |
| i | Imaginary unit |
| Eᵣₓ | Phase noise matrix at RX |
| Eₜₓ | Phase noise matrix at TX |

1. A computer-implemented transceiver method between at least one receiver and at least one transmitter in an overloaded communication channel that is characterized by a channel matrix, wherein,
within a first step, a transmitter sends one or more reference signals to a receiver, and the receiver estimates a channel matrix;
within a second step, the receiver optimizes an RX beamforming matrix and a TX beamforming matrix jointly; and
within a third step, the TX beamforming matrix is sent to the transmitter out-of-band by using a control channel.

2. Method of claim 1, wherein the RX beamforming matrix and the TX beamforming matrix are calculated in such a manner that an alternating optimization is executed over the TX beamforming matrix and the RX beamforming matrix until a stable point is reached by optimizing a minimum mean square error and after convergence, and the TX beamforming matrix is scaled to satisfy a maximum transmit power constraint.

3. Method of claim 1, wherein a minimum mean square error based on a mean square error of the channels matrices that incorporates an impact of hardware imperfection modeled as phase noise at the transmitter and the receiver.

4. Method of claim 1, wherein the RX beamforming matrix and the TX beamforming matrix are integrated in beamforming circuitry for a use in user equipment of a wireless telecommunications network and in a basestation, the beamforming circuitry configured to receive at the user equipment, from the wireless telecommunications network, data requesting a selection of a non-zero integer number beam by the UE.

5. A user equipment comprising:
a display screen; and
beamforming circuitry according to claim 4.

6. Machine-readable instructions provided on at least one machine-readable medium, the machine-readable instructions, when executed by a User Equipment of a wireless telecommunications network having at least one basestation to cause processing hardware of the UE to obtain, from the wireless telecommunications network, reference signals specifying a non-zero integer beam to be calculated according to the computer-implemented transceiver method between the at least one receiver and the at least one transmitter in the overloaded communication channel that is characterized by a channel matrix as claimed in claim 1.

7. Machine readable instructions as claimed in claim 6, wherein the machine readable instructions, when executed, cause processing hardware of the UE to report from the UE to the wireless telecommunications network, reference signals wherein the RX beamforming matrix and the TX beamforming matrix are calculated in such a manner that an alternating optimization is executed over the TX beamforming matrix and the RX beamforming matrix until a stable point is reached by optimizing a minimum mean square error and after convergence, the TX beamforming matrix is scaled to satisfy a maximum transmit power constraint.

8. Circuitry for use in a basestation of a wireless telecommunications network, the circuitry comprising:
processing circuitry to calculate a RX beamforming matrix and a TX beamforming matrix in such a manner, that an alternating optimization is executed over the TX beamforming matrix and the RX beamforming matrix until a stable point is reached by optimizing a minimum mean square error and after convergence, the TX beamforming matrix is scaled to satisfy a maximum transmit power constraint.

9. A basestation of a wireless telecommunications network comprising:
a transceiver and the processing circuitry as claimed in claim 8.

10. A computer-implemented transceiver method between at least one receiver and at least one transmitter in an overloaded communication channel that is characterized by a channel matrix, the method comprising:
receiving, at a receiver, one or more reference signals, and estimating a channel matrix;
jointly calculating, at the receiver, an RX beamforming matrix and a TX beamforming matrix; and
sending, by the receiver, the TX beamforming matrix to the transmitter out-of-band using a control channel.

11. The method of claim 10, wherein jointly calculating the RX beamforming matrix and the TX beamforming matrix comprises calculating the TX beamforming matrix and the RX beamforming matrix until a stable point is reached by using a minimum mean square error and after convergence, the TX beamforming matrix is scaled to satisfy a maximum transmit power constraint.

12. The method of claim 11, wherein the minimum mean square error is based on a mean square error of the channels matrices that incorporate an impact of hardware imperfection modeled as phase noise at the transmitter and the receiver.
